(19) United States
(12) Patent Application Publication
(10) Pub. No.: US 2021/0404145 A1
(43) Pub. Date: Dec. 30, 2021

(54) OBSTACLE DETECTOR OF CONSTRUCTION VEHICLE

(71) Applicant: SAKAI HEAVY INDUSTRIES, LTD., Tokyo (JP)

(72) Inventor: Ryohei ENDO, Saitama (JP)

(21) Appl. No.: 17/321,352

(22) Filed: May 14, 2021

(30) Foreign Application Priority Data
Jun. 26, 2020 (JP) 2020-110159

(51) Int. Cl. E02F 9/20; G05D 1/02; G01S 13/87; G01S 13/931

(52) U.S. Cl. CPC E02F 9/205; G05D 1/0238; G05D 2201/0202; G01S 13/87; G01S 13/931; G05D 1/0257

(57) ABSTRACT

An obstacle detector of a construction vehicle includes: a plurality of millimeter-wave radars arranged side by side on at least one of a front surface and a rear surface of the construction vehicle; and a controller which determines presence or absence of obstacles based on measurement data measured by the millimeter-wave radars, wherein the controller determines presence or absence of the obstacles within a detection range where irradiation ranges of the millimeter-wave radars overlap a predetermined range set in advance.

### CROSS REFERENCE TO RELATED APPLICATIONS

The present application claims the benefit of priority to Japanese Patent Application No. 2020-110159 filed on Jun. 26, 2020, the disclosures of all of which are hereby incorporated by reference in their entireties.

### BACKGROUND OF THE INVENTION

### Field of the Invention

The present disclosure relates to an obstacle detector of a construction vehicle.

### Description of the Related Art

Recently, technological development to improve a working environment for workers at construction sites has been positively in progress. Japanese Patent Application Publication No. 2019-203774 discloses a technique to apply an optical detection system for detecting obstacles with use of a Time of Flight (TOF) sensor to a construction vehicle, for example. With this technique, when an obstacle is detected, the construction vehicle is automatically stopped by a Hydro Static Transmission (HST) brake or the like (emergency brake), for example. An optical system such as a TOF and a Lidar, or a millimeter-wave radar is used as a sensor to detect obstacles.

An optical detection system such as a TOF and a Lidar uses a near-infrared wavelength (700 to 1000 nm, frequency of 300 to 430 THz). Accordingly, the optical detection system has an advantage of high accuracy of detecting positions of obstacles, but also has a disadvantage of detecting steam and dust generated at a construction site.

Meanwhile, a millimeter-wave radar uses a long wavelength of about 1 to 15 mm (about frequency of 20 to 300 GHz) and is frequently used for automated driving of cars. The millimeter-wave radar has a long wavelength so that stream and dust having a small particle size are not detected. Therefore, the millimeter-wave radar is suitable for a rough construction site where a construction vehicle is operated.

However, a detection system with use of a millimeter-wave radar has a problem of low accuracy of detecting positions of obstacles, as compared with the optical detection system such as TOF or Lidar. Especially, when a plurality of obstacles are located close to each other, it is hard for the millimeter-wave radar to separately recognize each obstacle. If accuracy of detecting positions of obstacles is decreased, a construction vehicle may fail to recognize workers, who are recognized under ordinary circumstances, to have a risk that the workers may be hit by the construction vehicle while working. Further, in a case where the above-mentioned emergency brake is arranged in the construction vehicle, if accuracy of detecting positions of obstacles is decreased, the vehicle may stop frequently even though there is no emergency, to have a decrease in work efficiency.

### BRIEF SUMMARY OF THE INVENTION

Therefore, the present disclosure is to provide an obstacle detector of a construction vehicle capable of improving accuracy of detecting positions of obstacles by millimeter-wave radars.

To solve the problem described above, an aspect of an obstacle detector of a construction vehicle described in the present disclosure includes: a plurality of millimeter-wave radars arranged side by side on at least one of a front surface and a rear surface of the construction vehicle; and a controller which determines presence or absence of obstacles based on measurement data measured by the millimeter-wave radars, wherein the controller determines presence or absence of the obstacles within a detection range where irradiation ranges of the millimeter-wave radars overlap a predetermined range set in advance.

With the structure, the plurality of millimeter-wave radars are arranged side by side so that, when a plurality of obstacles are present, the obstacles are prevented from being recognized as a single object. Accordingly, accuracy of detecting positions of the obstacles is improved.

Further, the controller preferably identifies an obstacle closest in a moving direction of the construction vehicle to the construction vehicle as a reference obstacle and transmits a control signal based on position data of the reference obstacle.

With the structure, the controller transmits the control signal based on measurement data of only the reference obstacle closest to the construction vehicle so that the obstacle is prevented more reliably from getting hit by the construction vehicle. The control signal may be a warning signal for warning or a brake signal for emergency braking, for example.

Further, a width dimension of the predetermined area is preferable to be substantially the same as a width dimension of the construction vehicle.

For example, when the vehicle is operated as closely as possible to a wall or is turned, if an object, which does not have to be detected, is determined as an obstacle, there is a risk of a decrease in work efficiency. However, with the structure described above, an object in an outer area than a vehicle width is not determined as an obstacle, to prevent a decrease in work efficiency.

Further, radar irradiation axes of the millimeter-wave radars are in parallel to each other.

With the structure, the millimeter-wave radars easily detect the obstacles right in front thereof so that accuracy of detecting positions of obstacles is improved.

An obstacle detector of a construction vehicle disclosed in the present disclosure improves accuracy of detecting positions of obstacles by millimeter-wave radars.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1A is a plan view, and FIG. 1B is a side view, of an obstacle detector of a tire roller according to an embodiment of the present disclosure;

FIG. 2 is a plan view of the obstacle detector of a tire roller according to the present embodiment to indicate a detection range;

FIG. 3 illustrates a first comparative example when an obstacle is detected by one millimeter-wave radar;

FIG. 4 illustrates a second comparative example when an obstacle is detected by the one millimeter-wave radar;

FIG. 5 illustrates a third comparative example when obstacles are detected by the one millimeter-wave radar;

FIG. 6 illustrates a fourth comparative example when obstacles are detected by the one millimeter-wave radar; and

FIG. 7 illustrates a fifth comparative example when obstacles are detected by the one millimeter-wave radar.

### DETAILED DESCRIPTION OF THE INVENTION

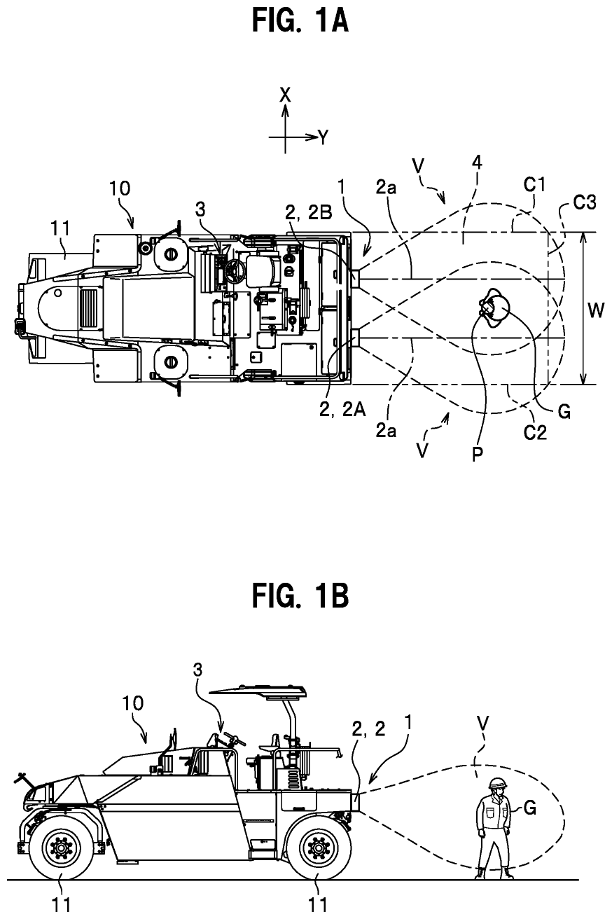

As illustrated in FIGS. 1A and 1B, in the present embodiment, a tire roller 10 is used as a construction vehicle, for example. In the description, a “longitudinal direction”, a “lateral (width) direction”, and a “vertical direction” are defined based on a position of an operator of the tire roller 10. Further, the lateral direction may be denoted by “X”, and the longitudinal direction may be denoted by “Y”.

<Structure>

In FIGS. 1A and 1B, an obstacle detector 1 of a construction vehicle of the present disclosure (hereinbelow, simply referred to as an “obstacle detector 1”) is mounted on a construction vehicle such as a compactor which compacts a road while moving at low speed. FIGS. 1A and 1B illustrate the tire roller 10 which compacts an asphalt road and the like by tires 11 and is mounted with the obstacle detector 1. The obstacle detector 1 includes two millimeter-wave radars 2 arranged side by side in the width direction and a controller 3. The obstacle detector 1 is mounted on the tire roller 10 in this embodiment but may be mounted on any other construction vehicles.

The millimeter-wave radar 2 is a device which transmits a radio wave in the millimeter-wave band to a surrounding area and receives a reflected wave reflected on an obstacle G, to measure a distance, an angle, a relative velocity, and the like with respect to the obstacle G. Various measurement types of the millimeter wave radar 2 may be used, including a Frequency Modulated-Continuous Wave (FM-CW) type, a dual frequency (multifrequency) CW type, a pulse (pulse doppler) type, and a spectrum diffusion type, and the type is not limited thereto.

In the present embodiment, two millimeter-wave radars 2 (2A, 2B) are arranged apart from each other on a rear surface of the vehicle. A distance between the millimeter-wave radars 2A and 2B may be appropriately set and is set to 30 to 150 cm, for example. Radar irradiation axes 2a of the millimeter-wave radars 2A and 2B are set to be in parallel to each other. An irradiation range V of each millimeter-wave radar 2 is substantially in a fan-shape in a plan view.

Here, a virtual line extending rearward along a right side surface of the vehicle of the tire roller 10 is referred to as a virtual line C1, and a virtual line extending rearward along a left side surface is referred to as a virtual line C2. Further, a virtual line in parallel to the rear surface of the vehicle and located approximately 3 meters away from the vehicle is referred to as a virtual line C3. An area, where a range surrounded by the virtual lines C1, C2, and C3 (predetermined range set in advance) overlaps the irradiation ranges V of the millimeter-wave radars 2A and 2B, is set as a detection range 4.

The controller 3 is a device which determines presence or absence of the obstacle G such as a person or a structure based on measurement data obtained by the millimeter-wave radars 2. The controller 3 is electrically connected to the millimeter-wave radars 2 and is arranged on an operation panel operated by the operator, for example. The controller 3 converts the measurement data obtained from the millimeter-wave radars 2 into a common X-Y coordinate, to identify a position data P (object position recognized by the millimeter-wave radars 2) of the obstacle G with respect to the vehicle. When the obtained position data P is determined to be within the detection range 4, the controller 3 determines that the obstacle G is present.

Further, in the present embodiment, the controller 3 includes a brake device (not shown) which brakes the vehicle under a predetermined condition when the controller 3 determines that the obstacle G is present in the detection range 4. The brake device may be an HST brake, for example. A condition, since the controller 3 has determined that the obstacle G is present till a brake signal is outputted, that is, a timing of starting a brake by the brake device may be changed, depending on a distance to the obstacle G, a moving speed of the vehicle, and the like.

The present embodiment includes the brake device to serve as an emergency brake but may include a warning device such as sound or light in combination with or in place of the brake device.

Further, in the present embodiment, the controller 3 identifies the obstacle G closest in a moving direction of the vehicle to the vehicle, for example, among a plurality of obstacles G as a “reference obstacle” and transmits a control signal (such as a brake signal and a warning signal) to the brake device, the warning device, or the like, based on the position data P of the reference obstacle. When a plurality of obstacles G are present, the controller 3 identifies an obstacle, which has the minimum value in Y-direction components of the obstacles G, as a reference obstacle. Further, when only one obstacle G is present, the controller 3 identifies the obstacle as a reference obstacle.

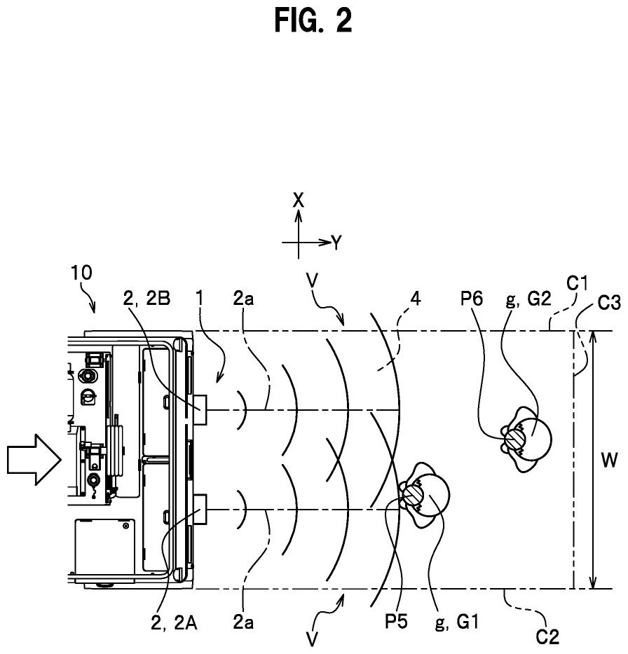

Next, a description is given of an example of operation of the obstacle detector 1 with reference to FIG. 2. In FIG. 2, the objects g are present behind the vehicle, which are away from each other in the longitudinal direction and the lateral direction.

When having obtained the measurement data of the objects g from the millimeter-wave radars 2A, 2B, the controller 3 converts the measurement data into a common X-Y coordinate, to calculate position data P5 and P6 of the objects g.

Next, the controller 3 calculates whether the position data P5 and P6 are included in the detection range 4. When the position data is included in the detection range 4, the controller 3 determines that these objects g are obstacles (obstacles G1, G2).

Next, the controller 3 calculates the minimum value in the Y-direction components of the obstacles G1, G2. In the example, the Y-direction component of the obstacle G1 has the minimum value so that the obstacle G1 is identified as a “reference obstacle”.

Next, the controller 3 transmits a brake signal under a predetermined condition based on the position data P5 corresponding to the obstacle G1 as a reference obstacle, especially the Y-direction component of the position data P5. Accordingly, the obstacles G1, G2 are prevented from getting hit by the vehicle.

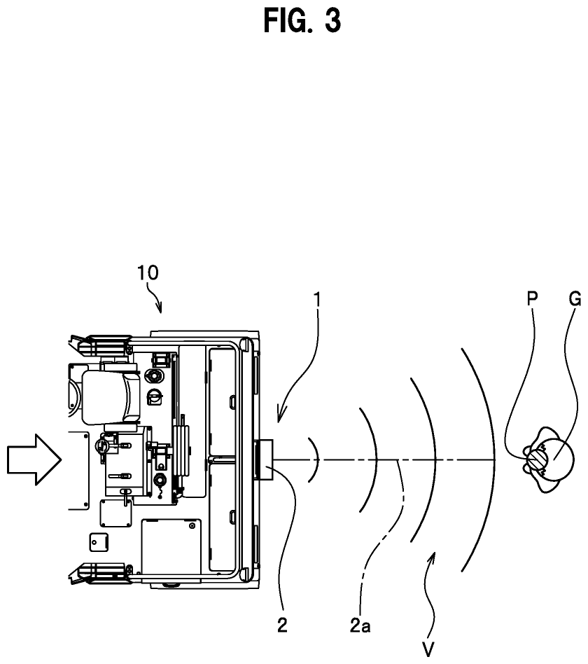

A description is given of a technical significance of the obstacle detector 1 of the present embodiment with reference to comparative examples. As illustrated in FIGS. 3 to 7, each of a first to fifth comparative examples includes one millimeter-wave radar 2 at the rear of the tire roller 10 in the center in the width direction. The tire roller 10 is assumed to move rearward (in a direction indicated by an open arrow in the drawings) for compaction operation.

### First Comparative Example

FIG. 3 illustrates the first comparative example when an obstacle is detected by one millimeter-wave radar. As illustrated in FIG. 3, in the first comparative example, one obstacle G is present. Further, the obstacle G is located right in front of the millimeter-wave radar 2 (on the radar irradiation axis 2a) so that the controller 3 identifies the position data P at a position substantially the same as an actual position of the obstacle G.

### Second Comparative Example

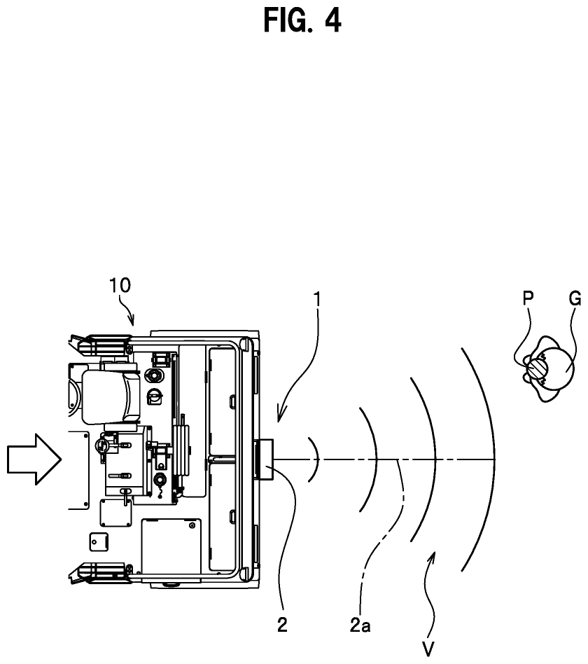

FIG. 4 illustrates the second comparative example when an obstacle is detected by one millimeter-wave radar. As illustrated in FIG. 4, in the second comparative example, one obstacle G is present. Further, though the obstacle G is located off a position right in front of the millimeter-wave radar 2 (position away in the width direction from the radar irradiation axis 2a), the controller 3 identifies the position data P at a position substantially the same as an actual position of the obstacle G.

### Third Comparative Example

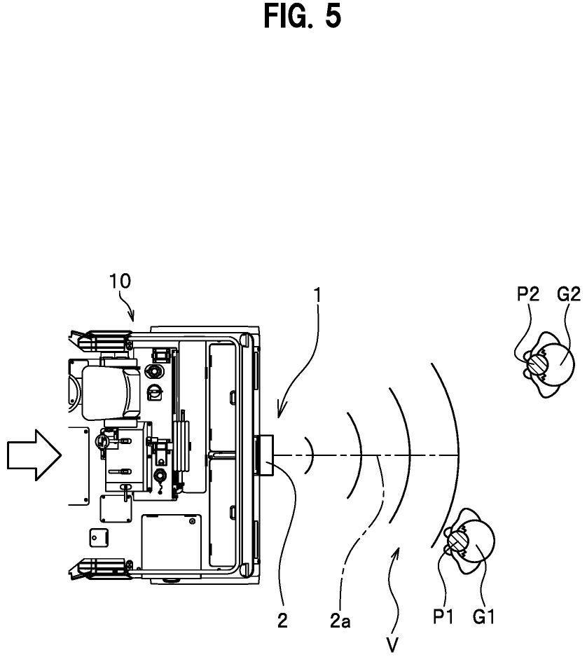

FIG. 5 illustrates the third comparative example when obstacles are detected by one millimeter-wave radar. As illustrated in FIG. 5, in the third comparative example, two obstacles G1, G2 are present. Both obstacles G1, G2 are located off positions right in front of the millimeter-wave radar 2. More specifically, the obstacles G1, G2 are located at positions on opposite sides from each other in the width direction with respect to the radar irradiation axis 2a and are also away from each other in the longitudinal direction. In this case, the controller 3 identifies position data P1, P2 at substantially the same positions as actual positions of the obstacles G1, G2, respectively. In other words, the obstacles G1, G2 are sufficiently away from each other in the width direction so that the controller 3 does not recognize the obstacles as a single object and separately recognizes the obstacles.

### Fourth Comparative Example

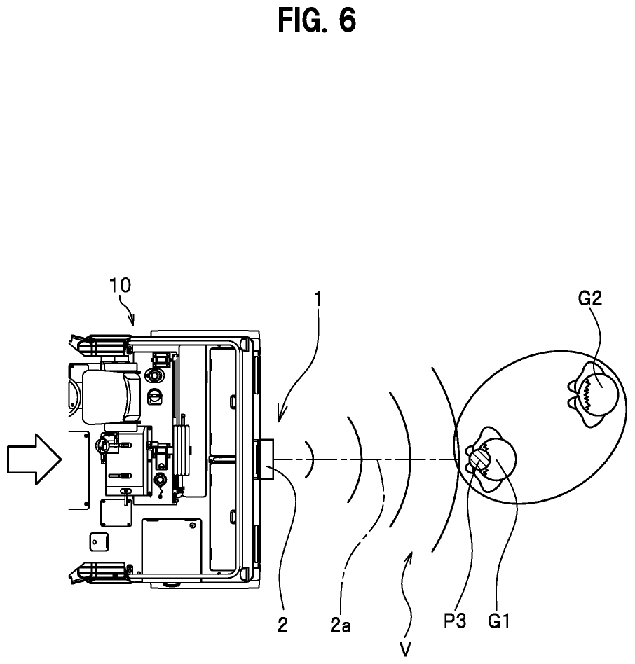

FIG. 6 illustrates the fourth comparative example when obstacles are detected by one millimeter-wave radar. As illustrated in FIG. 6, in the fourth comparative example, two obstacles G1, G2 are present. The obstacle G1 is located on the radar irradiation axis 2a. On the other hand, the obstacle G2 is located away in the width direction from the radar irradiation axis 2a and behind the obstacle G1. In this case, the obstacles G1, G2 are located close to each other so that the controller 3 tends to recognize the obstacles as a single object. However, the obstacle G1 is on the radar irradiation axis 2a and in front of the obstacle G2 so that the controller 3 identifies the integrated object as position data P3. In the fourth comparative example, the controller 3 recognizes the two obstacles as a single object, and recognizes the position of the obstacle G1 closer to the vehicle as the position data P3. Therefore, the obstacle detector has no problem. That is, as long as the position of the obstacle G1 closest to the vehicle is identified, there is little risk that the obstacles G1, G2 are hit by the vehicle.

### Fifth Comparative Example

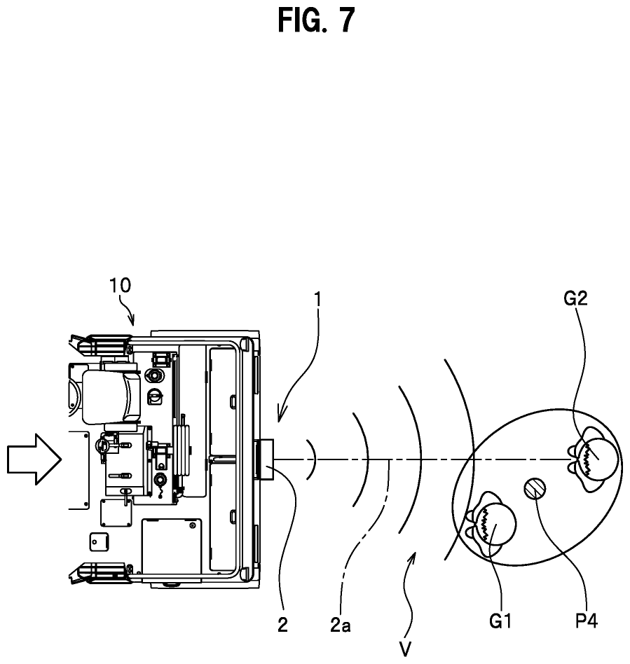

FIG. 7 illustrates the fifth comparative example when obstacles are detected by one millimeter-wave radar. As illustrated in FIG. 7, in the fifth comparative example, two obstacles G1, G2 are present. The obstacle G1 is located at a position away in the width direction from the radar irradiation axis 2a. On the other hand, the obstacle G2 is located on the radar irradiation axis 2a and behind the obstacle G1. In this case, the controller 3 tends to recognize the obstacles as a single object. The obstacle G2 is on the radar irradiation axis 2a so that the controller 3 identifies the single object as position data P4. That is, the controller 3 tends to give weight to the obstacle G2 on the radar irradiation axis 2a so that the position data P4 of the single object is identified at a location behind the obstacle G1. In the fifth comparative example, the obstacle G1 is present in front of the position data P4 of the single object which has been recognized by the controller 3 so that the obstacle G1 may be hit by the vehicle.

As described above, in the case where one millimeter-wave radar 2 is mounted on the vehicle, when one obstacle G is present, there is no problem in accuracy of detecting a position of the obstacle (first and second comparative examples). Further, even when a plurality of obstacles G are present, there may be no problem in accuracy of detecting positions of the obstacles (third and fourth comparative examples). However, in such a case as the fifth comparative example, accuracy of position detection is decreased with one millimeter-wave radar 2, to have a problem. That is, the millimeter-wave radar 2 has high accuracy of detecting a position of the obstacle G located right in front of the millimeter-wave radar 2 in a relatively short distance. On the other hand, when one obstacle G is located off a position right in front of the millimeter-wave radar 2 to either leftward or rightward in a relatively short distance, and another obstacle G is present behind the one obstacle G and right in front of the millimeter-wave radar 2, there is a risk of accuracy of position detection being decreased.

In contrast, in the present embodiment, as illustrated in FIG. 2, the plurality of millimeter-wave radars 2 (2A, 2B) are arranged side by side in the obstacle detector 1. Therefore, when the plurality of obstacles G1, G2 are present, either of the millimeter-wave radars 2A, 2B likely detects one of the obstacles G1, G2 right in front of the millimeter-wave radars 2A, 2B, which prevents the obstacles G1, G2 from being recognized as a single object. Accordingly, accuracy of detecting positions of obstacles is improved.

Further, the controller 3 of the present embodiment identifies an obstacle G closest in a moving direction of the vehicle to the vehicle as a “reference obstacle” and transmits a control signal such as a brake signal, for example, based on position data of the reference obstacle. With the structure, the controller 3 correctly recognizes a position of an obstacle closest to the vehicle. This prevents more reliably an obstacle G from getting hit by a construction vehicle. In other words, the present embodiment prevents position data (position data P4) of one obstacle (obstacle G1) closest to the vehicle from being recognized at a position behind the one obstacle, as in the fifth comparative example.

Further, as illustrated in FIG. 1A, in a case where the irradiation ranges V of the millimeter-wave radars 2 are used as detection ranges as they are, when the vehicle is operated as closely as possible to a wall or is turned, it may be determined that an obstacle G is present, causing the vehicle to stop unnecessarily even though a risk of collision is low. Consequently, work efficiency is decreased. On that point, in the present embodiment, a width dimension of a predetermined area (predetermined area set in advance) is set to be the same as a width dimension W of the tire roller 10. Accordingly, work efficiency is improved. Further, the virtual line C3 is set at the rear of the detection range 4 to prevent the vehicle from being stopped unnecessarily so that work efficiency is improved.

Note that the width direction of the detection range 4 (width dimension of the predetermined area) may be set on an inner or outer side, by a predetermined distance, of the virtual lines C1, C2.

Further, the millimeter-wave radars 2A, 2B of the present embodiment are arranged side by side on the rear surface of the vehicle, and the radar irradiation axes 2a thereof are in parallel to each other. Therefore, as compared with a case where the radar irradiation axes 2a are not in parallel to each other, either of the millimeter-wave radars 2A, 2B likely detects an obstacle, which is present in the detection range 4, right in front of the millimeter-wave radars 2A, 2B. Thus, accuracy of detecting positions of obstacles within the detection range 4, which has been made smaller, is further improved.

Still further, in a work site of a construction vehicle, especially a compactor as in the present embodiment, workers, security guards, structures, and the like are present in a small range. Contacting them, collision with them, hitting them and the like have to be avoided. Meanwhile, it is desired to stop the vehicle at a point very close to the vehicle from the viewpoint of work efficiency, for the vehicle provided with the emergency brake as with the present embodiment. On that point, the present embodiment improves accuracy of position detection within a short distance from the vehicle so that work environment and work efficiency are improved.

Here, in a case where one millimeter-wave radar 2 is arranged, as in the case of FIG. 4, and the obstacle G is located off a position right in front thereof, for example, another construction vehicle may be operated behind the tire roller 10. That is, a plurality of construction vehicles may be operated within a short distance.

In such a case, the millimeter-wave radar 2 tends to strongly respond to metal obstacles. Therefore, there is also a problem that the controller 3 recognizes another construction vehicle but fails to recognize the obstacle G located at a closer position with respect to the tire roller 10 in FIG. 4. However, in the present embodiment, the two millimeter-wave radars 2 are arranged side by side in the width direction so that the millimeter-wave radar 2A may detect the obstacle G and the millimeter-wave radar 2B may detect another construction vehicle. Further, in this case, the obstacle G relatively closer to the tire roller 10 is identified as a “reference obstacle”, preventing the obstacle G from getting hit by the tire roller 10.

The embodiment of the present disclosure has been described above, but design may be changed as appropriate. In the present embodiment, the two millimeter-wave radars 2 are arranged, but three or more millimeter-wave radars 2 may be arranged. Further, the plurality of millimeter-wave radars may be arranged side by side in the vertical direction, in place of the width direction of the tire roller 10.

Further, in the present embodiment, the millimeter-wave radars 2 are arranged on the rear surface of the vehicle but may be arranged on at least one of a front surface and the rear surface of the vehicle.

Of note, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, and/or “including,” when used in this specification, specify the presence of stated features, integers, steps, operations, elements, and/or components, but do not preclude the presence or addition of one or more other features, integers, steps, operations, elements, components, and/or groups thereof.

As well, the corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

1. An obstacle detector of a construction vehicle, comprising:
a plurality of millimeter-wave radars arranged side by side on at least one of a front surface and a rear surface of the construction vehicle; and
a controller which determines presence or absence of obstacles based on measurement data measured by the millimeter-wave radars,
wherein the controller determines presence or absence of the obstacles within a detection range where irradiation ranges of the millimeter-wave radars overlap a predetermined range set in advance.

2. The obstacle detector of a construction vehicle as claimed in claim 1, wherein the controller identifies an obstacle closest in a moving direction of the construction vehicle to the construction vehicle as a reference obstacle and transmits a control signal based on position data of the reference obstacle.

3. The obstacle detector of a construction vehicle as claimed in claim 1, wherein a width dimension of the predetermined area is substantially the same as a width dimension of the construction vehicle.

4. The obstacle detector of a construction vehicle as claimed in claim 2, wherein a width dimension of the predetermined area is substantially the same as a width dimension of the construction vehicle.

5. The obstacle detector of a construction vehicle as claimed in claim 1, wherein radar irradiation axes of the millimeter-wave radars are in parallel to each other.

6. The obstacle detector of a construction vehicle as claimed in claim 2, wherein radar irradiation axes of the millimeter-wave radars are in parallel to each other.

7. The obstacle detector of a construction vehicle as claimed in claim 3, wherein radar irradiation axes of the millimeter-wave radars are in parallel to each other.

8. The obstacle detector of a construction vehicle as claimed in claim 4, wherein radar irradiation axes of the millimeter-wave radars are in parallel to each other.
